(19) United States
(12) Patent Application Publication
(10) Pub. No.: US 2009/0072699 A1
(43) Pub. Date: Mar. 19, 2009

(54) CATHODE RAY TUBE WITH IMPROVED MASK ASSEMBLY

(76) Inventors: Hae-Su Youn, Suwon-si (KR); Bong-Kyung Suk, Suwon-si (KR); Kuen-Dong Ha, Suwon-si (KR); Do-Hun Pyun, Suwon-si (KR); Jong-Hoon Lim, Suwon-si (KR); Won-Bok Lee, Suwon-si (KR)

Correspondence Address: CHRISTIE, PARKER & HALE, LLP, PO BOX 7068, PASADENA, CA, 91109-7068, US

(21) Appl. No.: 12/121,707

(22) Filed: May 15, 2008

(30) Foreign Application Priority Data
Sep. 13, 2007 (KR) 10-2007-0093150

(51) Int. Cl. H01J 29/80

(52) U.S. Cl. 313/402

(57) ABSTRACT

A cathode ray tube including a shadow mask. The shadow mask includes an aperture portion including a plurality of beam guide holes, a non-aperture portion surrounding the aperture portion, and a skirt portion that is bent from an edge of the non-aperture portion toward an electron gun. The non-aperture portion includes a pair of longer sides, a pair of shorter sides, and four corner portions, and a first width of the non-aperture portion measured at the longer side and a second width of the non-aperture portion measured at the shorter side are formed to be less than a third width of the non-aperture portion measured at the corner portions. The shadow mask satisfies the following conditions: 2 mm≦w1<w3, and 2 mm≦w2<w3, where w1 denotes the first width of the non-aperture portion, w2 denotes the second width of the non-aperture portion, and w3 denotes the third width of the non-aperture portion.

### CROSS-REFERENCE TO RELATED APPLICATION

This application claims priority to and the benefit of Korean Patent Application No. 10-2007-0093150 filed in the Korean Intellectual Property Office on Sep. 13, 2007, the entire content of which is incorporated herein by reference.

### BACKGROUND OF THE INVENTION

(a) Field of the Invention

The present invention relates to a cathode ray tube. More particularly, the present invention relates to an improved mask assembly for a cathode ray tube.

(b) Description of the Related Art

Usually, in a cathode ray tube, three electron beams emitted from an electron gun are deflected by deflection magnetic field. The three electron beams are gathered in beam guide holes provided on a shadow mask. The beams flow through the beam guide holes to separately collide with red, green, and blue phosphors of a phosphor screen. The phosphor layers receiving the electron beams emit light to realize a predetermined color image.

A mask assembly includes the shadow mask and a mask frame, and the shadow mask selects the three electron beams emitted from the electron gun to land the electron beams on to corresponding phosphor layers. Accordingly, it is required to maintain positions of the beam guide holes of the shadow mask to guarantee high image quality of the cathode ray tube.

However, since electron beam transmittance of the shadow mask is only approximately 20%, kinetic energy of the remaining 80% of the electron beams that collide with the shadow mask is converted into thermal energy.

Accordingly, a doming phenomenon in which the shadow mask is thermally expanded occurs when driving the cathode ray tube. Due to the doming phenomenon, the electron beams are miss-landed since the positions of the beam guide holes and the phosphors are not matched, and therefore a color purity of a screen is deteriorated.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention is a cathode ray tube for improving a shape of a mask assembly, suppressing a doming phenomenon of the shadow mask, and minimizing deterioration of color purity of a screen that is caused by miss-landing electron beams.

According to an exemplary embodiment of the present invention, a cathode ray tube includes a vacuum tube, an electron gun, a deflection yoke, and a shadow mask. The tube includes a panel in which a fluorescence screen is formed, a funnel that is provided to a rear part of the panel, and a neck. The electron gun is inside the neck, while the deflection yoke is outside the funnel. The shadow mask is positioned inside the panel while having a predetermined distance to the fluorescence screen, and includes an aperture portion including a plurality of beam guide holes, a non-aperture portion surrounding the aperture portion, and a skirt portion that is bent from an edge of the non-aperture portion toward the electron gun. The non-aperture portion includes a pair of longer sides, a pair of shorter sides, and four corner portions, and a first width of the non-aperture portion measured at the longer side and a second width of the non-aperture portion measured at the shorter side are formed to be less than a third width of the non-aperture portion measured at one of the corner portion.

In some embodiments, the shadow mask satisfies “2 mm≦w1<w3”, and “2 mm≦w2<w3”, where w1 denotes the first width of the non-aperture portion, w2 denotes the second width of the non-aperture portion, and w3 denotes the third width of the non-aperture portion.

In some embodiments, the cathode ray tube has an over-scan area that is greater than that of the aperture portion of the shadow mask. The first width of the non-aperture portion is formed to be less than a distance between an edge of the over-scan area measured at the longer side and the aperture portion, and the second width of the non-aperture portion is formed to be less than a distance between an edge of the over-scan area measured at the shorter side and the aperture portion. However, the third width of the non-aperture portion is formed to be greater than a distance between an edge of the over-scan area measured at the corner portion and the aperture portion. The over-scan area is 1.08 times an area of the aperture portion.

In some embodiments, the shadow mask includes a cutout portion in the skirt portion to partially reduce a width of the skirt portion. The cathode ray tube may further include a mask frame for supporting the shadow mask, and the mask frame is formed along an outer line of the skirt portion to correspond to the skirt portion.

### BRIEF DESCRIPTION OF THE DRAWINGS

FIG. 1 is a partially cut-away perspective view of a cathode ray tube according to an exemplary embodiment of the present invention.

FIG. 2 is a perspective view of a mask assembly shown in FIG. 1.

FIG. 3 is a cross-sectional view of a shadow mask and a mask frame shown in FIG. 2.

FIG. 4 is a top plan view of the shadow mask and the mask frame shown in FIG. 2.

FIG. 5 is a graph representing the amount of landing electron beams by thermal expansion of the shadow mask.

FIG. 6 is a graph representing the amount of landing electron beams caused by the thermal expansion of the mask frame.

FIG. 7 is a graph representing the amount of landing electron beams caused by the thermal expansion of spring members.

FIG. 8 is a graph representing the amount of landing electron beams according to the thermal expansion of the shadow mask, the mask frame, and the spring members.

FIG. 9 is a schematic diagram of a partial scan area in a screen of the cathode ray tube.

FIG. 10 is a schematic diagram representing a point for measuring the amount of landing electron beams.

FIG. 11 is a perspective view representing an exemplary variation of a shadow mask.

### DETAILED DESCRIPTION OF THE EMBODIMENTS

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention.

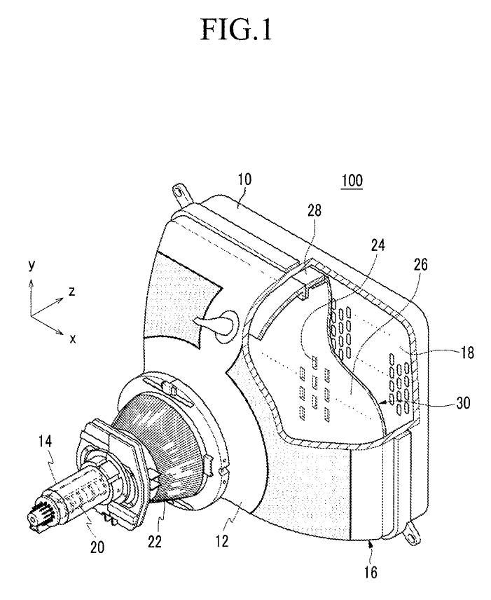

FIG. 1 is a partially cut-away perspective view of a cathode ray tube according to an exemplary embodiment of the present invention.

As shown in FIG. 1, a cathode ray tube 100 includes a vacuum tube 16 formed by integrating a panel 10, a funnel 12, and a neck 14. A fluorescence screen 18 including red, green, and blue phosphors is formed inside the panel 10, and an electron gun 20 for emitting three electron beams toward the fluorescence screen 18 is formed inside the neck 14. A deflection yoke 22 for generating a deflection magnetic field on the electron beam path to deflect the electron beams is formed outside the funnel 12.

A shadow mask 26 including a plurality of beam guide holes 24 with a predetermined distance to the fluorescence screen 18 is formed inside the panel 10. The shadow mask 26 functions as a color selecting electrode for selecting the three electron beams emitted from the electron gun to land them to phosphor layers corresponding to respective colors. In addition, the shadow mask 26, a mask frame 28, and a spring member (not shown) form a mask assembly 30.

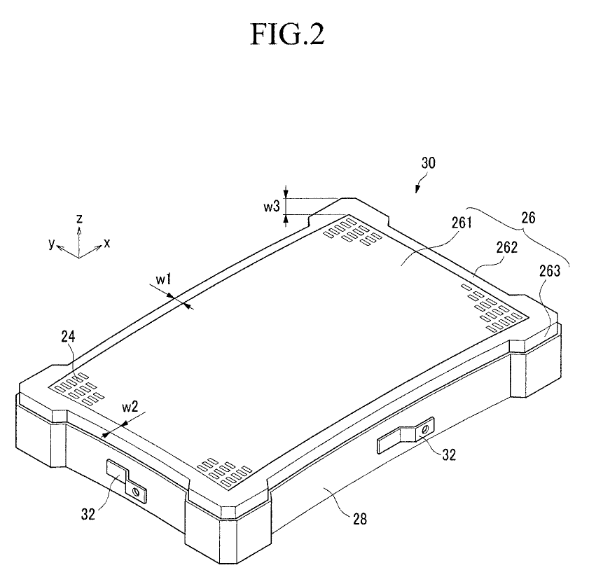

FIG. 2 is a perspective view of the mask assembly shown in FIG. 1.

As shown in FIG. 2, the mask assembly 30 includes the shadow mask 26 including the beam guide holes 24, the mask frame 28 fixed on an edge of the shadow mask 26 (for example, by a welding method) to support the shadow mask 26, and spring members 32 fixed on the mask frame 28. The spring members 32 are fixed to stud pins (not shown) provided inside the panel 10 to position the shadow mask 26 to the inside of the panel 10.

The shadow mask 26 also includes an aperture portion 261 including the beam guide holes 24, a non-aperture portion 262 surrounding the aperture portion 261, and a skirt portion 263 bent from the non-aperture portion 262 toward a rear part of the cathode ray tube. The aperture portion 261, the non-aperture portion 262, and the skirt portion 263 each include a pair of longer sides that are parallel to a horizontal direction of a cathode ray tube screen (i.e., an x-axis direction in the drawings) and a pair of shorter sides that are parallel to a vertical direction of the cathode ray tube screen (i.e., a y-axis direction in the drawings).

In an exemplary embodiment of the present invention, the shadow mask 26 is formed such that the non-aperture portion 262 has a different width according to its position. That is, the widths of the non-aperture portion 262 include a first width w1 for the pair of longer sides, a second width w2 for the pair of shorter sides, and a third width w3 for each corner portion, where the third width w3 is formed to be different from the first and second widths w1 and width w2.

The third width w3 of the non-aperture portion 262 has a value that is greater than values of the first width w1 and the second width w2, and the first width w1 and the second width w2 may have the same values or different values. The skirt portion 263 is formed to be bent from the edges of the non-aperture portion 262 having respective widths toward the rear part of the cathode ray tube. Variations of the widths of the non-aperture portion 262 reduce the doming phenomenon of the shadow mask 26 and the amount of the landing electron beams.

In further detail, the widths w1, w2, and w3 of the non-aperture portion 262 may be established based on the size of an over-scan area.

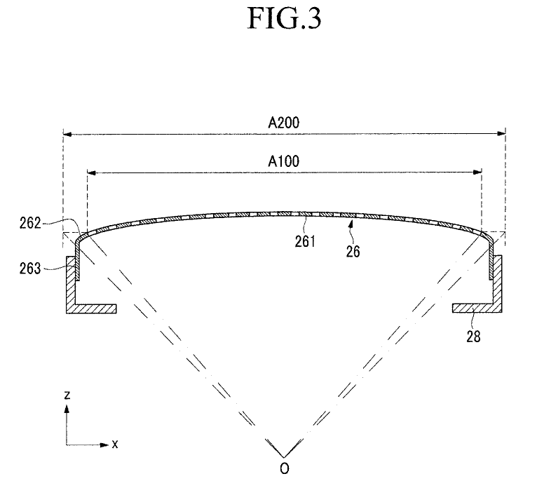

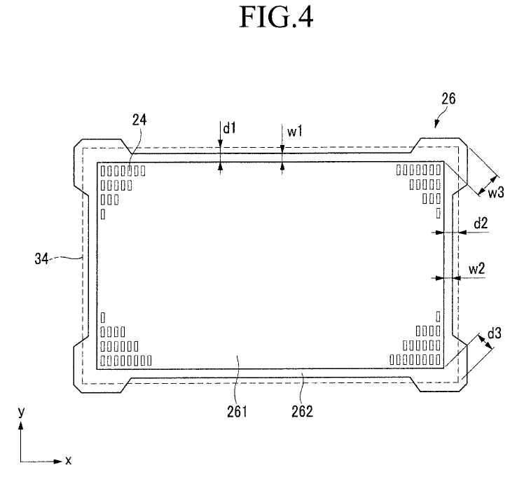

FIG. 3 is a cross-sectional view of the shadow mask and mask frame shown in FIG. 2, and FIG. 4 is a top plan view of the shadow mask and mask frame shown in FIG. 2.

Referring to FIG. 1, the three electron beams emitted from the electron gun 20 are deflected by horizontal and vertical deflection magnetic fields generated by the deflection yoke 22, and respective pixels of the fluorescence screen 18 are sequentially scanned. In FIG. 3, an electron beam emission point is illustrated as O.

Referring to FIG. 3 and FIG. 4, when an electron beam scan area is the same as an area of the aperture portion 261, an outermost scan position of the electron beam is the edge of the aperture portion 261. In this case, the electron beam scan area measured in the horizontal direction (i.e., the x-axis direction in the drawings) of the screen of the cathode ray tub is denoted by A100 in FIG. 3.

However, in a conventional case, the electron beam scan area is larger than the area of the aperture portion 261 since the electron beam is over-scanned. In this case, the electron beam scan area measured in the horizontal direction (i.e., the x-axis direction of the screen of the cathode ray tube), that is, the over-scan area is denoted by A200 in FIG. 3, and an edge of an over-scan area 34 is illustrated as dotted lines in FIG. 4. The over-scan area 34 may be 1.08 times the area of the aperture portion 261.

In an exemplary embodiment of the present invention, the first width w1 of the non-aperture portion 262 in the shadow mask 26 is less than a distance d1 between the edge of the over-scan area 34 measured in the longer side and the aperture portion 261, shown in FIG. 4. The second width w2 of the non-aperture portion 262 is less than a distance d2 between the edge of the over-scan area 34 measured in the shorter side and the aperture portion 261, shown in FIG. 4. In addition, the third width w3 of the non-aperture portion 262 is greater than a distance d3 between the edge of the over-scan area 34 measured in the corner portion and the aperture portion 261, shown in FIG. 4.

The first width w1 and the second width w2 of the non-aperture portion 262 are greater than 2 mm. In this condition, a shape error of the shadow mask 26 in a process for forming the shadow mask 26 may be prevented.

Referring back to FIG. 2, the mask frame 28 is formed in the same shape as the skirt portion 263 along an outer line of the skirt portion 263, and is fixed to the skirt portion 263 on the inside or outside of the skirt portion 263 by, for example, a welding method. In FIG. 2, it is illustrated that the mask frame 28 is provided outside the skirt portion 263.

Referring back to FIG. 1, the three electron beams emitted from the electron gun 20 are deflected by the deflection magnetic field, the three electron beams are gathered and pass through the beam guide holes 24 of the shadow mask 26. The three electron beams are then separated to collide with corresponding red, green, and blue phosphors of the fluorescence screen 18, and the phosphor layers receiving the electron beams emit light with predetermined luminance. Therefore the cathode ray tube 100 realizes a predetermined color image.

In the above operations, 80% of the emitted electron beams may not pass through the beam guide holes 24 and so collide with the shadow mask 26 and thus the kinetic energy of the colliding electron beams is converted in to thermal energy. Accordingly, the doming phenomenon in which the shadow mask 26 is thermally expanded occurs.

The doming phenomenon of the shadow mask 26 includes x-axis doming that is parallel to the horizontal direction of the cathode ray tube screen, y-axis doming that is parallel to the vertical direction of the cathode ray tube screen, and z-axis doming that is parallel to a z direction in the drawings. The x-axis doming and the z-axis doming affect an electron beam path.

The x-axis doming moves the electron beams toward the screen edge, and the z-axis doming moves the electron beams to a center of the screen. Hereinafter, a landing movement of the electron beams toward the screen edge will be referred to as “outward”, and a landing movement of the electron beams toward the center of the screen will be referred to as “inward”.

Heat of the shadow mask 26 is transmitted to the mask frame 28 and the spring members 32. Accordingly, thermal expansion of the mask assembly 30 includes a first step in which the shadow mask 26 is expanded, a second step in which the mask frame 28 is expanded, and a third step in which the spring members 32 are expanded. A combination of the thermal expansion of the shadow mask 26, the mask frame 28, and the spring members 32 determines positions of the beam guide holes 24 and the amount of the landing electron beams.

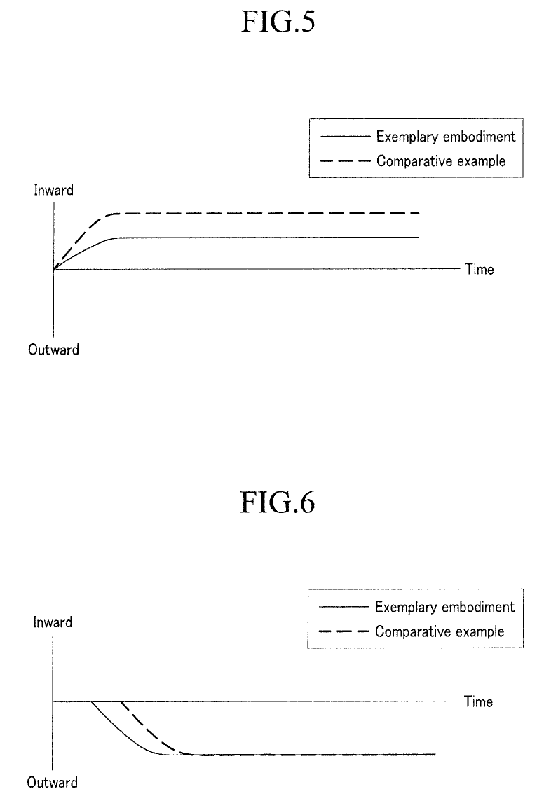

FIG. 5 is a graph representing the amount of the landing electron beams by the thermal expansion of the shadow mask in the first step. In a cathode ray tube according to a comparative example, a first width of a non-aperture portion measured in a longer side is greater than a third width measured in a corner portion, and a second width measured in a shorter side is less than the third width.

Referring to FIG. 5, the shadow mask is thermally expanded toward the fluorescence screen after the cathode ray tube is started to be driven, and a fixed doming pattern is shown in a predetermined time. In the cathode ray tube according to the comparative example, the doming of the shadow mask mainly includes z-axis doming, and therefore, the cathode ray tube according to the comparative example shows inward landing movement.

However, since the widths in the shorter and longer sides are reduced in the cathode ray tube according to the exemplary embodiment of the present invention, the doming of the shadow mask includes x-axis doming and z-axis doming. Therefore, the x-axis doming causes the electron beams to be outward and the landing movement by the z-axis doming is reduced.

FIG. 6 is a graph representing the amount of the landing electron beams caused by the thermal expansion of the mask frame in the second step.

Referring to FIG. 6, the shadow mask is thermally expanded, the heat of the shadow mask is transmitted to the mask frame, and the mask frame is thermally expanded toward an outer side of the mask frame. The shadow mask has the x-axis doming by the thermal expansion of the mask frame, and the thermal expansion of the mask frame reduces the doming of the shadow mask. In the second step, the outward landing movement of the comparative example and the exemplary embodiment are the same.

However, since the non-aperture potion of the cathode ray tube according to the exemplary embodiment of the present invention has a reduced widths of the longer and shorter sides except for four corner portions, the heat of the shadow mask is quickly transmitted to the mask frame. Accordingly, the thermal expansion of the mask frame in the cathode ray tube according to an exemplary embodiment of the present invention is started earlier than the cathode ray tube according to the comparative example, and the doming of the shadow mask is further efficiently reduced.

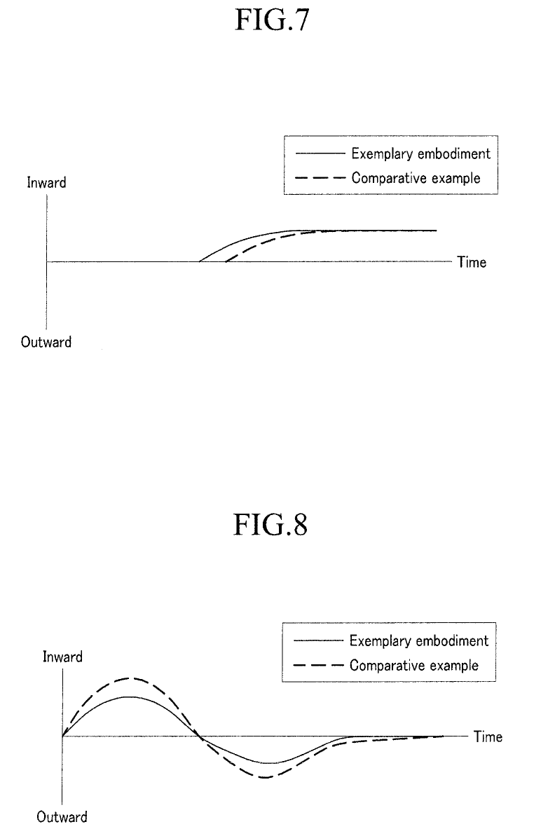

FIG. 7 is a graph representing the amount of the landing electron beams caused by the thermal expansion of the spring members in the third step.

Referring to FIG. 7, the mask frame is thermally expanded, the heat of the mask frame is transmitted to the spring members, and the spring members are thermally expanded. The shadow mask has z-axis doming by the thermal expansion of the spring members, and the thermal expansion of the spring members reduces the landing movement by the thermal expansion of the mask frame.

In the third step, the amount of inward landing movement of the comparative example and the exemplary embodiment are the same. The thermal expansion of the spring members in the cathode ray tube according to the exemplary embodiment of the present invention is started earlier than in the cathode ray tube according to the comparative example, and the doming of the shadow mask is further efficiently reduced.

The corner portion of the shadow mask has no z-axis doming in the three steps. Accordingly, the x-axis doming is not problematically increased at the corner portion of the shadow mask when the mask frame is excessively increased. Since the non-aperture potion of the cathode ray tube according to the exemplary embodiment of the present invention has the increased widths of the respective edges, the x-axis doming is prevented from being excessively increased.

FIG. 8 is a graph representing the amount of the landing electron beams according to the thermal expansion of the shadow mask, the mask frame, and the spring members.

Referring to FIG. 8, the amount of the landing electron beams measured in the cathode ray tube according to an exemplary embodiment of the present invention is reduced to be less than that of the cathode ray tube according to the comparative example. Accordingly, color purity of the screen of the cathode ray tube according to the exemplary embodiment of the present invention is improved, and improved image quality may be realized.

Table 1 shows experimental results of the amount of landing electron beams in the cathode ray tube according to the exemplary embodiment of the present invention and the cathode ray tube according to the comparative example.

TABLE 1

| | | Exemplary | Comparative |
|---|---|---|---|
| | | embodiment | example |
| Size (mm) | Exterior of | 544.5/315.0/634.5 | 562.5/329.0/ |
| (Horizontal/ | shadow | | 634.5 |
| Vertical/ | mask | | |
| Diagonal) | Width of | 13.3/4.4/17.0 | 22.3/11.4/17.0 |
| | non- | | |
| | aperture | | |
| | portion | | |
| | Width of | 14/14/14 | 14/14/14 |
| | skirt portion | | |

| | | | | Stable | Peak | Stable |
|---|---|---|---|---|---|---|
| | | | Peak value | value | value | value |
| Amount | Full | ½ Point | −71 (57.7%) | −54.2 (61.0%) | −123 | −88.9 |
| of | scan | | | | | |
| landing | | ⅔ Point | −98 (60.9%) | −73.7 (64.1%) | −161 | −115 |
| electron | | | | | | |
| beams (μm) | | Horizontal | −126 (63.3%) | −89.3 (65.7%) | −199 | −136 |
| | | reference | | | | |
| | | point | | | | |
| | | Diagonal | −16.7 (35.5%) | −6.0 (23.0%) | −47 | −26.1 |
| | | reference | | | | |
| | | point | | | | |
| | | Stable value | | 83.3 | | 19.9 |
| | | difference | | | | |

| | | | |
|---|---|---|---|
| Partial | ½ Point | −152 (89.4%) | −170 |
| scan | ⅔ Point | −172 (85.1%) | −202 |
| | Horizontal | −206 (70.1%) | −294 |
| | reference | | |
| | point | | |

The first and second widths (i.e., the widths of the longer and shorter sides) of the non-aperture portion in the cathode ray tube according to an exemplary embodiment of the present invention are reduced compared to the cathode ray tube according to the comparative example, and the third width of the non-aperture portion measured on the corner portion is the same as that of the cathode ray tube according to the comparative example.

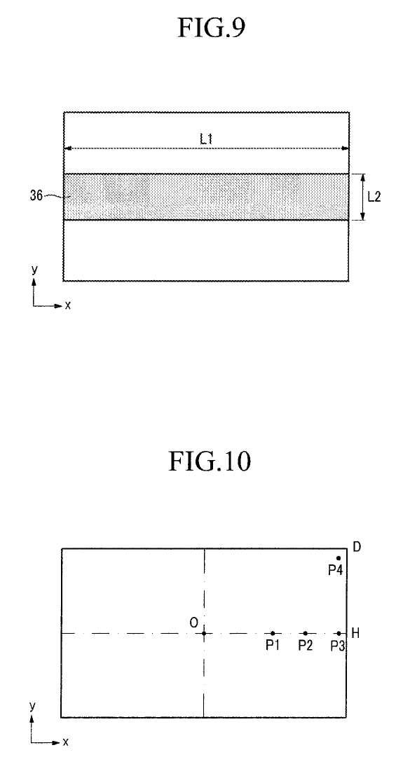

In Table 1, the fluorescence screen is over-scanned 1.08 times the area of the aperture portion to perform the full scan, and the fluorescence screen is partially scanned to perform the partial scan as shown in FIG. 9. A horizontal direction length L1 of a partial scan area 36 is the same as a horizontal direction length of a full scan area, and a vertical direction length L2 is 0.25 times a vertical direction length of the full scan area.

The amount of landing electron beams is measured at a ½ point, a ⅔ point, a horizontal reference point, and a diagonal reference point, which are shown in FIG. 10.

Referring to FIG. 10, a ½ point P1 is a middle point between a screen center point O and a horizontal end point H, and a ⅔ point P2 is parted from the screen center point O by ⅔ of a line between the screen center point O and the horizontal end point H divided in three. The horizontal reference point P3 is parted from the horizontal end point H toward the screen center point O by 30 mm, and the diagonal reference point P4 is parted from a diagonal end D toward the screen center point O by 20 mm in a horizontal direction and by 20 mm in a vertical direction.

The amount of landing electron beams in the cathode ray tube is a maximum value of an initial driving state of the cathode ray tube, and the amount of landing electron beams is stabilized to a predetermined value since the thermal expansion of the mask frame and the spring members are combined as a driving time increases. In Table 1, a peak value is a maximum value of the amount of landing electron beams measured after the cathode ray tube is driven for five minutes, and a stable value is a stabilized value of the amount of landing electron beams measured after the cathode ray tube is driven for one hour.

A stable value difference is a difference between a stable value measured at the horizontal reference point and a stable value measured at the diagonal reference point. When assuming that the amount of landing electron beams measured in the cathode ray tube according to the comparative example is 100%, a ratio of the amount of landing electron beams measured in the cathode ray tube according to the exemplary embodiment of the present invention is denoted by % in parenthesis.

As shown in Table 1, the amount of landing electron beams measured in the cathode ray tube according to the exemplary embodiment of the present invention is reduced to be less than in the cathode ray tube according to the comparative example in the full scan and the partial scan. In the cathode ray tube according to the exemplary embodiment of the present invention, 40% of shadow mask doming is reduced when the cathode ray tube is initially driven, and a doming balance is improved since the difference (i.e., the stable value difference) between the amount of the electron beams measured at the horizontal reference point and that of the diagonal reference point is reduced.

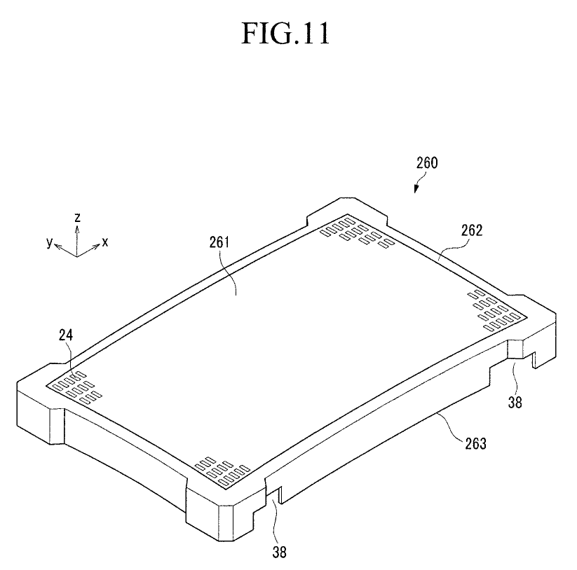

FIG. 11 is a perspective view representing an exemplary variation of the shadow mask shown in FIG. 2.

As shown in FIG. 11, in a shadow mask 260 according to an exemplary embodiment of the present invention, a cutout portion 38 is formed in the skirt portion 263 to partially reduce the width of the skirt portion 263. 10 pieces of the manufactured shadow masks 260 are accumulated to be transported or stored, and in this case, the shadow masks 260 may be efficiently accumulated by the cutout portion 38 provided in the skirt portion 263.

The cutout portion 38 is formed on a part of the longer side and a part of the corner portion of the skirt portion 263, or it is formed on a part of the shorter side and a part of the corner portion of the skirt portion 263. In FIG. 11, it is illustrated that the cutout portion 38 is formed on the part of the longer side and the part of the corner portion of the skirt portion 263.

As described, the cathode ray tube according to the exemplary embodiments of the present invention suppresses the doming phenomenon of the shadow mask by improving the shape of the non-aperture portion. Accordingly, the cathode ray tube according to the exemplary embodiments of the present invention reduces the amount of the landing electron beams, and therefore color purity of a screen is improved.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A cathode ray tube comprising:
a vacuum tube comprising a panel in which a fluorescence screen is formed, a funnel that is provided to a rear part of the panel, and a neck;
an electron gun positioned inside the neck;
a deflection yoke positioned outside the funnel; and
a shadow mask positioned inside the panel with a predetermined distance to the fluorescence screen and having an aperture portion including a plurality of beam guide holes, a non-aperture portion surrounding the aperture portion, and a skirt portion bent from an edge of the non-aperture portion toward the electron gun,
wherein the non-aperture portion includes a pair of longer sides, a pair of shorter sides, and four corner portions, and a first width of the non-aperture portion measured at the longer side and a second width of the non-aperture portion measured at the shorter side are formed to be less than a third width of the non-aperture portion measured at one of the corner portions,
wherein the shadow mask satisfies the following conditions: 2 mm≦w1<w3, and 2 mm≦w2<w3, where w1 denotes the first width of the non-aperture portion, w2 denotes the second width of the non-aperture portion, and w3 denotes the third width of the non-aperture portion.

2. The cathode ray tube of claim 1, wherein the cathode ray tube has an over-scan area that is greater than an area of the aperture portion of the shadow mask.

3. The cathode ray tube of claim 2, wherein the first width of the non-aperture portion is formed to be less than a distance between an edge of the over-scan area measured at the longer side, and the aperture portion.

4. The cathode ray tube of claim 2, wherein the second width of the non-aperture portion is formed to be less than a distance between an edge of the over-scan area measured at the shorter side, and the aperture portion.

5. The cathode ray tube of claim 2, wherein the third width of the non-aperture portion is formed to be greater than a distance between an edge of the over-scan area measured at the corner portion, and the aperture portion.

6. The cathode ray tube of claim 2, wherein the over-scan area is 1.08 times the area of the aperture portion.

7. The cathode ray tube of claim 1, wherein the shadow mask includes a cutout portion in the skirt portion to partially reduce a width of the skirt portion.

8. The cathode ray tube of claim 1, further comprising a mask frame for supporting the shadow mask, wherein the mask frame is formed along an outer line of the skirt portion to correspond to the skirt portion.
